(19) United States
(12) Patent Application Publication
(10) Pub. No.: US 2026/0322672 A1
(43) Pub. Date: Oct. 15, 2026

(54) COMMUNICATION SYSTEM AND COMMUNICATION METHOD USING PRE-CHANNEL EQUALIZATION

(71) Applicant: RESEARCH COOPERATION FOUNDATION OF YEUNGNAM UNIVERSITY, Gyeongsangbuk-do (KR)

(72) Inventors: KWONHUE CHOI, Daegu (KR); JUWHAN KIM, Daegu (KR); HYUNGSEOP SON, Daegu (KR)

(21) Appl. No.: 18/834,349

(22) PCT Filed: Apr. 2, 2024
(86) PCT No.: PCT/KR2024/004249

§ 371 Date: Jul. 30, 2024

(30) Foreign Application Priority Data
Nov. 29, 2023 (KR) 10-2023-0170139

(51) Int. Cl. H04L 27/26

(52) U.S. Cl. CPC H04L 27/2639; H04L 27/2607

(57) ABSTRACT

A communication method for signal transmission of a transmitter in a communication system using pre-channel equalization includes generating a zero padding section or a cyclic prefix (CP) section in a foremost section of a data frame in any one of a delay-Doppler domain, a frequency-time domain, and a delay-time domain, and generating a transmission signal by performing pre-equalization on a signal in any one of the delay-Doppler domain, the frequency-time domain, and the delay-time domain.

### CROSS REFERENCE TO RELATED APPLICATION AND CLAIM OF PRIORITY

This application claims benefit under 35 U.S.C. 119, 120, 121, or 365(c), and is a National Stage entry from International Application No. PCT/KR2024/004249, filed Apr. 2, 2024 which claims priority to the benefit of Korean Patent Application No. 10-2023-0170139 filed in the Korean Intellectual Property Office on Nov. 29, 2023, the entire contents of which are incorporated herein by reference.

### BACKGROUND

### 1. Technical Field

Embodiments of the present disclosure relate to communication technology using pre-channel equalization.

### 2. Background Art

In recent years, the speed of mobile objects equipped with wireless communication technology, such as autonomous driving vehicles or drones, is increasing. Accordingly, the demand for orthogonal time frequency space (OTFS), which exhibits high performance in communication between high-speed mobile objects, is increasing. OTFS is used in single-user and multi-user cases, and may be divided into an uplink structure and a downlink structure depending on whether a sender is a user or a base station.

FIG. 1 is a diagram showing a signal transmission and reception process between a transmitter and a receiver in a general orthogonal time frequency space (OTFS) in different domains.

Referring to FIG. 1, the transmitter may generate an original data signal, map the original data signal to a delay-Doppler domain of size M×N, and then convert the original data signal to a signal in a frequency-time domain by performing the inverse symplectic fast Fourier transform (ISFFT). That is, the signal in the delay-Doppler domain may be converted to the signal in the frequency-time domain by spreading it in two dimensions through ISFFT operation. In addition, a transmission signal in the delay-time domain may be generated by performing inverse fast Fourier transform (IFFT) on the data signal in the frequency-time domain, and the generated transmission signal may be transmitted to the receiver. In this case, the transmission signal passes through a wireless channel and is received by the receiver.

Then, at the receiver, fast Fourier transform (FFT) is performed on the received signal in the delay-time domain to convert the received signal into a signal in the frequency-time domain, and symplectic fast Fourier transform (SFFT) is performed on the signal in the frequency-time domain to generate an original data estimation signal in the delay-Doppler domain.

Since delay spreading occurs in the wireless channel due to the multipath effect when a signal is transmitted from the transmitter to the receiver, zero padding is put to a back section of a data frame to prevent inter-symbol interference due to the delay spreading. In FIG. 1, the zero padding section is indicated by z.

Meanwhile, in the case of a multi-user uplink OTFS system, delay-time domain signals transmitted by different users pass through different wireless channels and are received by a single receiver in the delay-Doppler domain in a state of invading each other's areas. This will be described with reference to FIGS. 2 to 4 as follows. FIGS. 2 to 4 are diagrams showing a state in which interference between users occurs in a multi-user environment of an OTFS system.

First, in FIG. 2, it can be seen that four users have generated data X_{Dd,1} to X_{Dd,4} in locations that do not overlap each other. Here, for convenience of description, a signal for each of the four users is separately displayed, but in reality, one signal generated by combining the signals of the four users is received.

Next, FIG. 3 shows a state in which the signals of four users are received by the receiver through respective channels, and it can be seen that since signals R_{dD,1} to R_{dD,4} of the respective users pass through different channels, the signals suffer from channel distortion in different ways and thus invade each other's areas.

Here, as shown in FIG. 4, when user 1's channel is compensated, user 1's channel is compensated, but channels of remaining users, that is, user 2, user 3, and user 4, are not compensated according to their own channels, but compensated according to user 1's channel, and thus, it can be seen that the signal spreads further into other users' areas. As such, in the OTFS system in the multi-user environment, there is a problem in that interference between users increases and the bit error rate (BER) performance deteriorates.

### SUMMARY

Embodiments of the present disclosure are intended to provide a communication system and a communication method using pre-channel equalization, capable of reducing interference between users.

Embodiments of the present disclosure are intended to provide a communication system and a communication method using pre-channel equalization, capable of reducing the amount of calculation of a receiver.

A communication method according to one embodiment disclosed herein is a method for signal transmission of a transmitter in a communication system using pre-channel equalization, and the communication method is performed in a computing device including one or more processors and a memory storing one or more programs executed by the one or more processors and includes generating a zero padding section or a cyclic prefix (CP) section in a foremost section of a data frame in any one of a delay-Doppler domain, a frequency-time domain, and a delay-time domain and generating a transmission signal by performing pre-equalization on a signal in any one of the delay-Doppler domain, the frequency-time domain, and the delay-time domain.

The pre-equalization may be to perform compensation in a direction opposite to spread of data to occur in a channel between the transmitter and a receiver in advance before transmitting a signal from the transmitter to the receiver.

The generating of the transmission signal may include acquiring channel information between the transmitter and a receiver to receive the transmission signal, generating an equalization matrix based on the channel information, and generating the transmission signal by multiplying the equalization matrix by a signal in any one of the delay-Doppler domain, the frequency-time domain, and the delay-time domain for each column.

The equalization matrix (Hₚᵣₑ) may be generated by Equation 1 or Equation 2 below.

$${H}_{pre} = \frac{{G}_{n}^{H}}{{G}_{n} {G}_{n}^{H} + {σ}_{0}^{2} {I}_{M}} \qquad ( Equation 1 )$$

$${H}_{pre} = \frac{{G}_{n}^{H}}{{G}_{n} {G}_{n}^{H}} \qquad ( Equation 2 )$$

Gₙ: Channel matrix for an n-th column of a signal matrix in the delay-time domain

$${G}_{n}^{H} :$$

Hermitian matrix of Gₙ

$${σ}_{0}^{2} :$$

Dispersion of noise of a corresponding channel
I_{M}: Identity matrix corresponding to a length M of the n-th column of the signal matrix in the delay-time domain

In the generating of the transmission signal, the transmission signal (x_{pre,n}) may be generated by multiplying the equalization matrix for each column according to Equation 3 or Equation 4 below, and each column of the transmission signal may be concatenated to generate a matrix of the transmission signal.

$${x}_{pre , n} = \frac{{G}_{n}^{H}}{{G}_{n} {G}_{n}^{H} + {σ}_{0}^{2} {I}_{M}} {x}_{n} \qquad ( Equation 3 )$$

$${x}_{pre , n} = \frac{{G}_{n}^{H}}{{G}_{n} {G}_{n}^{H}} {x}_{n} \qquad ( Equation 4 )$$

xₙ: n-th column of a signal matrix in the delay-time domain

The communication system may be an orthogonal time frequency space (OTFS) communication system, and the communication method may further include, prior to the generating of the zero padding section or the CP section, receiving data bits, digitally modulating the data bits, and mapping the modulated data symbols to the delay-Doppler domain, performing inverse symplectic fast Fourier transform (ISFFT) on the signal in the delay-Doppler domain to convert the signal into a signal in the frequency-time domain, and performing inverse fast Fourier transform (IFFT) on the signal in the frequency-time domain to generate a signal in the delay-time domain.

The communication system may be an orthogonal frequency division multiplexing (OFDM) communication system, and the communication method may further include, prior to the generating of the zero padding section or the CP section, receiving data bits, digitally modulating the data bits, and mapping the modulated data symbols to the frequency-time domain, and performing inverse fast Fourier transform (IFFT) on the signal in the frequency-time domain to generate a signal in the delay-time domain.

A communication method according to another embodiment disclosed herein is a communication method for signal reception of a receiver in a communication system using pre-channel equalization, and the communication method is performed in a computing device including one or more processors and a memory storing one or more programs executed by the one or more processors and includes receiving, from a transmitter, a transmission signal for which a zero padding section or a cyclic prefix (CP) section is generated in a foremost section of a data frame in any one of a delay-Doppler domain, a frequency-time domain, and a delay-time domain and in which pre-equalization in performed on a signal in any one of the delay-Doppler domain, the frequency-time domain, and the delay-time domain.

A communication system according to one embodiment disclosed herein is a communication system using pre-channel equalization and including a transmitter and a receiver, and the transmitter includes a channel equalizer configured to generate a transmission signal by generating a zero padding section or a cyclic prefix (CP) section in a foremost section of a data frame in any one of a delay-Doppler domain, a frequency-time domain, and a delay-time domain, and performing pre-equalization on a signal in any one of the delay-Doppler domain, the frequency-time domain, and the delay-time domain.

A communication system according to another embodiment disclosed herein is a communication system using pre-channel equalization and including a transmitter and a receiver and the receiver receives, from the transmitter, a transmission signal for which a zero padding section or a cyclic prefix (CP) section is generated in a foremost section of a data frame in any one of a delay-Doppler domain, a frequency-time domain, and a delay-time domain and in which pre-equalization is performed on a signal in any one of the delay-Doppler domain, the frequency-time domain, and the delay-time domain.

A communication method according to still another embodiment disclosed herein is a communication method for signal transmission of a transmitter in a communication system using pre-channel equalization, and the communication method is performed in a computing device including one or more processors and a memory storing one or more programs executed by the one or more processors and includes acquiring channel information between the transmitter and a receiver, generating an equalization matrix based on the channel information, and generating a transmission signal by multiplying the equalization matrix by a signal in any one of a delay-Doppler domain, a frequency-time domain, and a delay-time domain for each column.

A communication method according to yet another embodiment disclosed herein is a communication method using pre-channel equalization of a transmitter that is a user terminal in a communication system of an uplink multi-user scenario, and the communication method is performed in a computing device including one or more processors and a memory storing one or more programs executed by the one or more processors, and includes acquiring channel information between the transmitter and a receiver, generating an equalization matrix based on the channel information, and generating a transmission signal by multiplying the equalization matrix by a signal in any one of a delay-Doppler domain, a frequency-time domain, and a delay-time domain for each column.

According to the disclosed embodiments, since when sending a data signal from a transmitter, a channel is equalized in advance before being sent, a receiver can receive signals of users without interfering with each other, thereby reducing interference between the users in a communication system used by multiple users. In addition, since the receiver receives a signal that has been channel-equalized in advance, there is no need for separate channel equalization, which can reduce the amount of calculation of the receiver.

### BRIEF DESCRIPTION OF THE DRAWINGS

FIG. 1 is a diagram showing a signal transmission and reception process between a transmitter and a receiver in a general orthogonal time frequency space (OTFS) at domain dimensions.

FIGS. 2 to 4 are diagrams showing a state in which interference between users occurs in a multi-user environment of an OTFS system.

FIGS. 5A and 5B are diagrams comparing channel compensation of an existing OTFS communication system and channel compensation of an OTFS communication system according to an embodiment of the present disclosure.

FIGS. 6A and 6B are diagrams comparing user interference of the existing OTFS communication system and user interference of the OTFS communication system according to an embodiment of the present disclosure.

FIGS. 7A and 7B are diagrams comparing a location of a zero padding section of the existing OTFS communication system and a location of a zero padding section of the OTFS communication system according to one embodiment of the present disclosure.

FIG. 8 is a diagram showing an OTFS communication system according to one embodiment of the present disclosure.

FIG. 9 is a diagram schematically showing a data signal processing process at a transmitter of the OTFS communication system according to one embodiment of the present disclosure.

FIG. 10 is a graph comparing bit error rate (BER) performances of the existing OTFS communication system and the OTFS communication system of the present disclosure in a multi-user environment.

FIG. 11 is a graph comparing peak to average power ratio (PAPR) performances of the existing OTFS communication system and the OTFS communication system of the present disclosure.

FIG. 12 is a flowchart showing a communication method of a communication system according to one embodiment of the present disclosure.

FIG. 13 is a block diagram exemplarily illustrating a computing environment that includes a computing device suitable for use in exemplary embodiments.

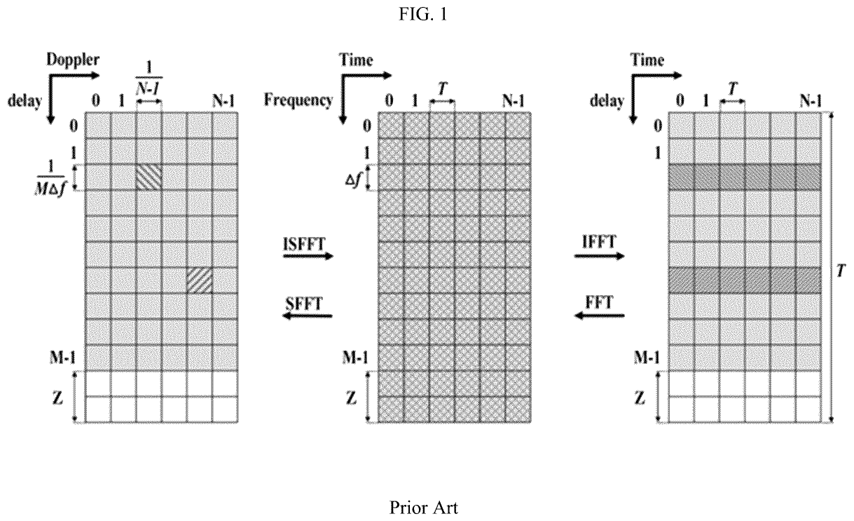

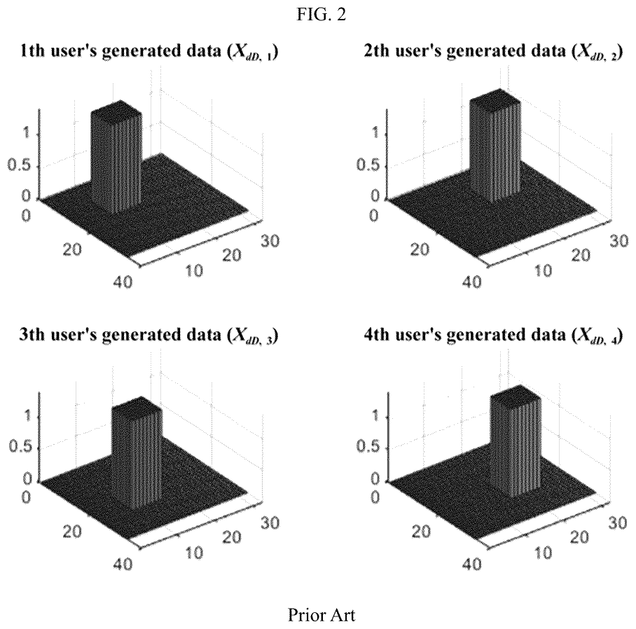

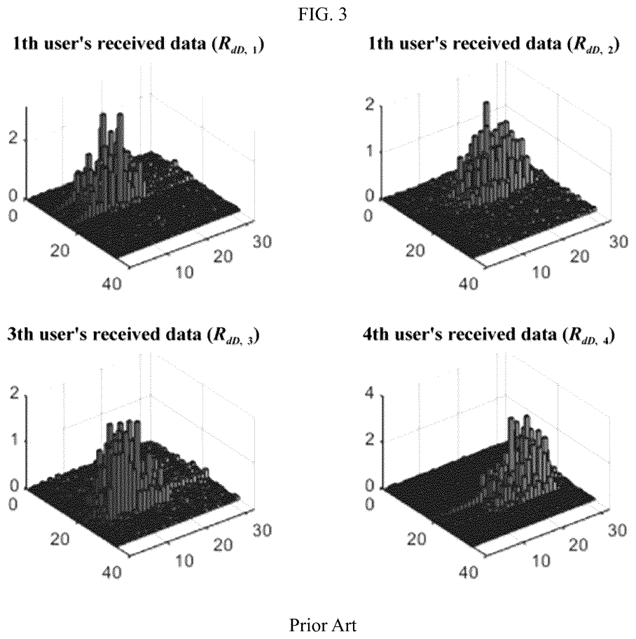

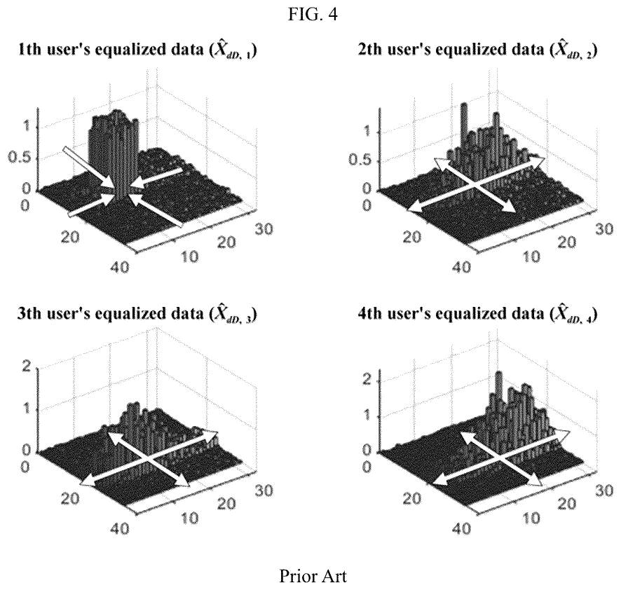

### DETAILED DESCRIPTION

Hereinafter, specific embodiments of the present invention will be described with reference to the accompanying drawings. The following detailed description is provided to assist in a comprehensive understanding of the methods, devices and/or systems described herein. However, the detailed description is only for illustrative purposes and the present invention is not limited thereto.

In describing the embodiments of the present invention, when it is determined that detailed descriptions of known technology related to the present invention may unnecessarily obscure the gist of the present invention, the detailed descriptions thereof will be omitted. The terms used below are defined in consideration of functions in the present disclosure, but may be changed depending on the customary practice, the intention of a user or operator, or the like. Thus, the definitions should be determined based on the overall content of the present specification. The terms used herein are only for describing the embodiments of the present invention, and should not be construed as limitative. Unless expressly used otherwise, a singular form includes a plural form. In the present description, the terms “including”, “comprising”, or the like are used to indicate certain characteristics, numbers, steps, operations, elements, and a portion or combination thereof, but should not be interpreted to preclude one or more other characteristics, numbers, steps, operations, elements, and a portion or combination thereof.

In the following description, the terminology “transmission”, “communication”, “reception” of a signal or information and terminology similar thereto may include a meaning in which the signal or information is directly transmitted from one element to another element and transmitted from one element to another element through an intervening element. In particular, “transmission” or “sending” of the signal or information to one element may indicate a final destination of the signal or information and may not imply a direct destination. The same is true for “reception” of the signal or information. In addition, in the present specification, a meaning in which two or more pieces of data or information are “related” indicates that when any one piece of data (or information) is obtained, at least a portion of other data (or information) may be obtained based thereon.

Meanwhile, directional terms such as top, bottom, one side, the other side, and the like, are used in connection with orientations of the disclosed figures. Since components of embodiments of the present disclosure can be positioned in various orientations, the directional terminology is used for purposes of illustration and not limitation.

Further, it will be understood that, although the terms first, second, etc. may be used herein to describe various elements, these elements should not be limited by these terms. These terms may be used to distinguish one element from another element. For example, without departing from the scope of the present disclosure, a first element could be termed a second element, and similarly, a second element could be termed a first element.

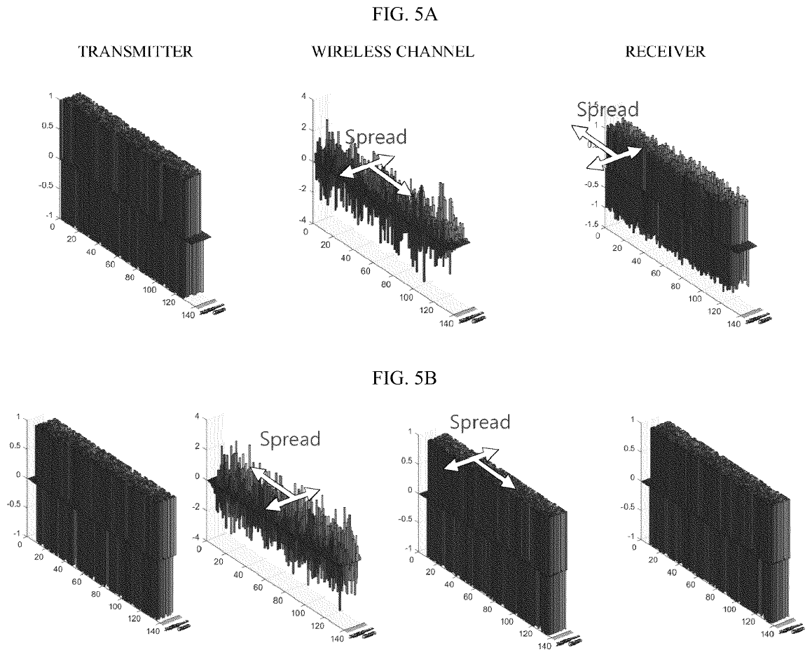

In the disclosed embodiment, in a communication system using orthogonal time frequency space (OTFS), when a transmitter transmits a data signal to a receiver, the transmitter may transmit the data signal after compensating for the distortion due to the influence of a channel in advance (that is, pre-equalizing). That is, FIGS. 5A and 5B are diagrams comparing channel compensation of an existing OTFS communication system and channel compensation of an OTFS communication system according to one embodiment of the present disclosure.

Looking at FIG. 5A, in the related art, when a data signal is transmitted from a transmitter, data spread occurs in a wireless channel due to the Doppler effect or the like, and the signal is received by a receiver in a distorted state. Then, the receiver compensates in the opposite direction of the distortion through channel equalization.

On the other hand, looking at FIG. 5B, in the disclosed embodiment, before transmitting the data signal by the transmitter, compensation is made through channel equalization in advance (that is, compensation in advance in the direction opposite to the spread of data to occur in the wireless channel) and then transmission is made. Then, data spreading occurs in the wireless channel in the opposite direction to channel equalization, so that the receiver receives the signal without channel distortion. In this case, since the receiver does not need to compensate for separate channel distortion (that is, channel equalization), the amount of calculation may be reduced.

In one embodiment, in the case in which the transmitter is a user terminal and the receiver is a base station, when each user terminal compensates for channel distortion in advance through channel equalization and then transmits a signal, the base station receives the signal without channel distortion and does not need separate channel equalization, and thus the calculation burden may be reduced. This reduction in the amount of calculation may have a greater effect in the case of multi-users. However, the present disclosure is not limited thereto, and of course may be applied even when the transmitter is a base station and the receiver is a user terminal.

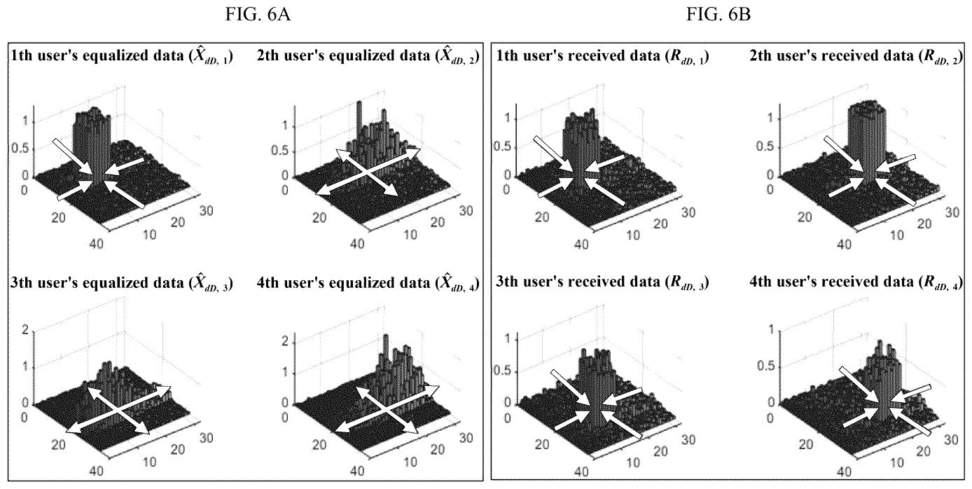

FIGS. 6A and 6B are diagrams comparing user interference of the existing OTFS communication system and user interference of the OTFS communication system according to an embodiment of the present disclosure. Here, for convenience of description, a signal for each of the four users is separately displayed, but in reality, one signal generated by combining the signals of the four users is received.

Looking at FIG. 6A, in the existing OTFS communication system, each user's signal suffers from channel distortion and invades each other's area, and when user 1's channel is compensated, the remaining users are compensated according to user 1's channel, and thus, rather, the signal spreads further into other users' areas, increasing interference between users.

On the other hand, looking at FIG. 6B, in the disclosed embodiment, when the transmitter transmits a data signal, the channel is equalized in advance and then the data signal is transmitted, and thus the signals of the users are received at the receiver without interference between each other (that is, without invading each other's areas), so it can be seen that there is no need for separate channel equalization. That is, according to the disclosed embodiment, it is possible to reduce interference between multiple users in the communication system used by the users.

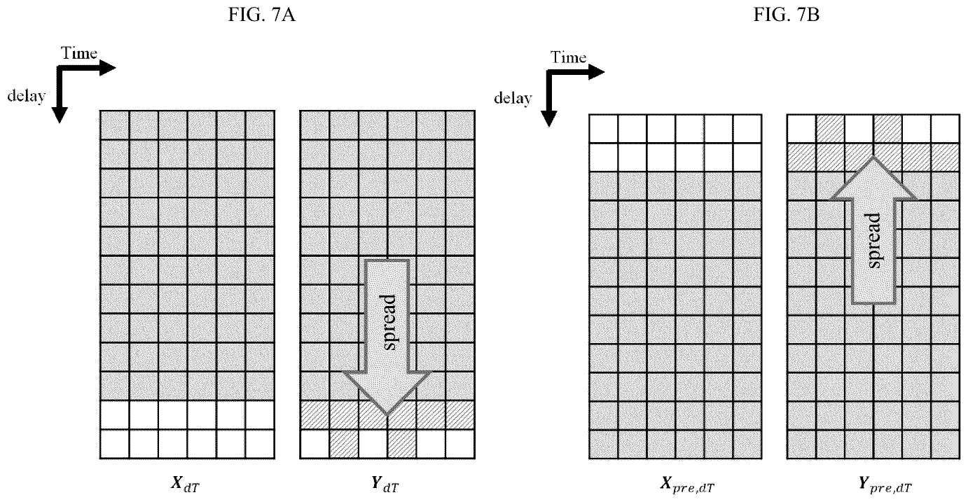

Meanwhile, in the disclosed embodiment, since the transmitter performs channel equalization in advance, a zero padding section may be generated in a foremost section of a data frame. FIGS. 7A and 7B are diagrams comparing a location of a zero padding section of the existing OTFS communication system and a location of a zero padding section of the OTFS communication system according to one embodiment of the present disclosure.

Looking at FIG. 7A, since, in the existing OTFS communication system, data spread due to the Doppler effect occurs in the wireless channel in the direction of time flow, the zero padding section is generated in the last section of the data frame to prevent data loss.

On the other hand, looking at FIG. 7B, since the OTFS communication system according to the disclosed embodiment performs channel equalization by reversely compensating for the data spread in the wireless channel (that is, in the opposite direction of time) at the transmitter in advance, data loss may be prevented by generating the zero padding section in the foremost section of the data frame.

Meanwhile, here, the zero padding section has been described as being generated in the foremost section of the data frame, but the present disclosure is not limited thereto, and the cyclic prefix (CP) section may also be generated in the foremost section of the data frame. That is, the zero padding section or the CP section may be generated in the foremost section of the data frame.

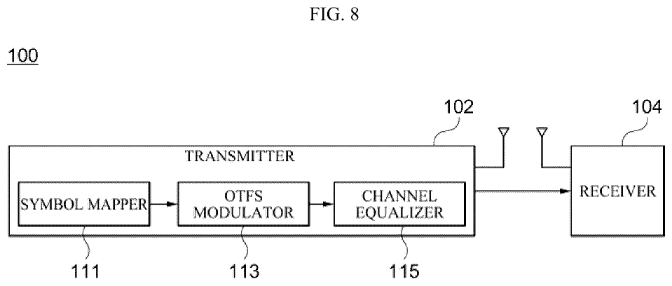

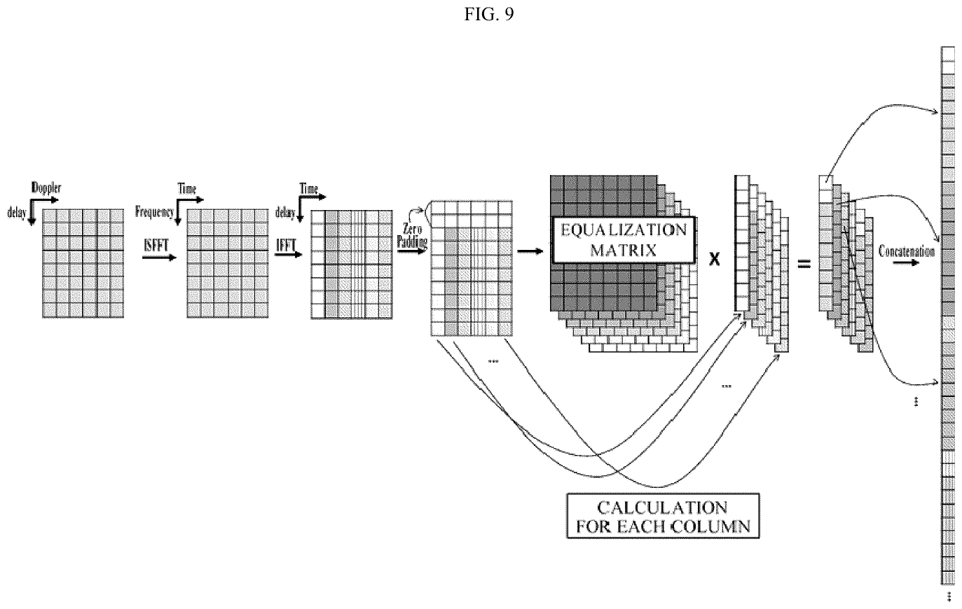

FIG. 8 is a diagram showing an OTFS communication system according to one embodiment of the present disclosure, and FIG. 9 is a diagram schematically showing a data signal processing process at a transmitter of the OTFS communication system according to one embodiment of the present disclosure. FIGS. 8 and 9, an OTFS communication system 100 may include a transmitter 102 and a receiver 104.

The transmitter 102 may include a symbol mapper 111, an OTFS modulator 113, and a channel equalizer 115. The symbol mapper 111 may receive data bits, digitally modulate them, and then map the modulated data symbols to a delay-Doppler domain (dD domain).

That is, the symbol mapper 111 may map each modulated data symbol to a data frame in the delay-Doppler domain. In this case, the data frame may be formed of a grid of size M×N. M may be the number of grid cells on a delay axis, and N may be the number of grid cells on a Doppler axis.

The OTFS modulator 113 may perform inverse symplectic fast Fourier transform (ISFFT) on the signal in the delay-Doppler domain to convert the signal into a signal in the frequency-time domain (FT domain), and perform inverse fast Fourier transform (IFFT) on the signal in the frequency-time domain to generate a signal in the delay-time domain (dT domain).

The channel equalizer 115 may serve to compensate for the influence of the channel in advance at the transmitter 102. The channel equalizer 115 may generate a zero padding section in a data frame in the delay-time domain. In this case, the zero padding section is generated in the foremost section of the data frame in the delay-time domain. That is, in the disclosed embodiment, since the transmitter 102 reversely compensates for data spread in the wireless channel in advance to equalize the channel, zero padding section may be generated in the foremost section of the data frame, thereby preventing data loss. According to the disclosed embodiment, the zero padding section is not generated until a signal in the delay-time domain is generated.

In addition, the channel equalizer 115 may generate an equalization matrix based on channel information between the transmitter 102 and the receiver 104. In one embodiment, the channel equalizer 115 may acquire channel information using a signal received from the receiver 104, but is not limited thereto, and the transmitter 102 may transmit a signal to the receiver 104 and receive feedback from the receiver 104 on channel information estimated by the receiver 104.

In one embodiment, the channel equalizer 115 may generate the equalization matrix according to channel information between the transmitter 102 and the receiver 104 using a minimum mean square error (MMSE) equalization technique. In this case, the channel equalizer 115 may generate a equalization matrix Hₚᵣₑ through Equation 1 below.

$${H}_{pre} = \frac{{G}_{n}^{H}}{{G}_{n} {G}_{n}^{H} + {σ}_{0}^{2} {I}_{M}} \qquad ( Equation 1 )$$

Gₙ: Channel matrix for an n-th column of a signal matrix in the delay-time domain

$${G}_{n}^{H} :$$

Hermitian matrix of Gₙ

$${σ}_{0}^{2} :$$

Dispersion of noise of a corresponding channel
I_{M}: Identity matrix corresponding to a length M of the n-th column of the signal matrix in the delay-time domain

Here, the use of the minimum mean square error (MMSE) equalization technique has been described as an example, but the channel equalizer is not limited thereto, and of course, various other equalization techniques, such as the Zero-Forcing technique, may be used. For example, the channel equalizer 115 may also generate the equalization matrix Hₚᵣₑ through Equation 2 below.

$${H}_{pre} = \frac{{G}_{n}^{H}}{{G}_{n} {G}_{n}^{H}} \qquad ( Equation 2 )$$

The channel equalizer 115 may generate a transmission signal to be transmitted to the receiver 104 by multiplying the equalization matrix Hₚᵣₑ by a signal in the delay-time domain in which a zero padding section is generated in the foremost section of the data frame for each column. When using the equalization matrix Hₚᵣₑ of Equation 1, the channel equalizer 115 may generate a transmission signal x_{pre,n} through Equation 3. The channel equalizer 115 may generate a matrix of the transmission signal by concatenating each column calculated by Equation 3. Likewise, of course, even when using the equalization matrix Hₚᵣₑ of Equation 2, a corresponding transmission signal may be generated.

$${x}_{p r e , n} = \frac{{G}_{n}^{H}}{{G}_{n} {G}_{n}^{H} + {σ}_{0}^{2} {I}_{M}} {x}_{n} \qquad ( Equation 3 )$$

xₙ: n-th column of the signal matrix in the delay-time domain

The receiver 104 may receive the transmission signal transmitted from the transmitter 102 through the channel. Then, the receiver 104 may perform fast Fourier transform (FFT) on the received signal in the delay-time domain to convert the received signal into a signal in the frequency-time domain, and perform symplectic fast Fourier transform (SFFT) on the signal in the frequency-time domain to generate an original data estimation signal in the delay-Doppler domain.

Meanwhile, here, it has been described that the transmitter 102 of the OTFS communication system compensates for the influence of the channel in advance and then transmits a signal, but the present disclosure is not limited thereto, and may also be applied to the transmitter of orthogonal frequency division multiplexing (OFDM) so that a signal is transmitted after compensating for the influence of the channel in advance.

In this case, an OFDM transmitter may receive data bits, digitally modulate the data bits and then map the modulated data symbols to the frequency-time domain. Next, a signal in the delay-time domain may be generated by performing inverse fast Fourier transform (IFFT) on the signal in the frequency-time domain, and then, through the channel equalizer, a zero padding section may be generated in the foremost section of the data frame and the equalization matrix may be multiplied by the signal in the delay-time domain for each column, thereby generating a transmission signal.

In addition, no matter what modulation method is used, the present disclosure may be applied to all communication systems in which at the transmitter, the zero padding section is generated in the foremost section of the data frame of the signal in the delay-time domain and the equalization matrix is multiplied by the signal in the delay-time domain for each column, thereby generating the transmission signal.

Further, here, it has been described that the transmission signal is generated by multiplying the equalization matrix by the signal in the delay-time domain for each column, but the present disclosure is not limited thereto and the transmission signal may be generated by multiplying the equalization matrix by the signal in the delay-Doppler domain or frequency-time domain for each column.

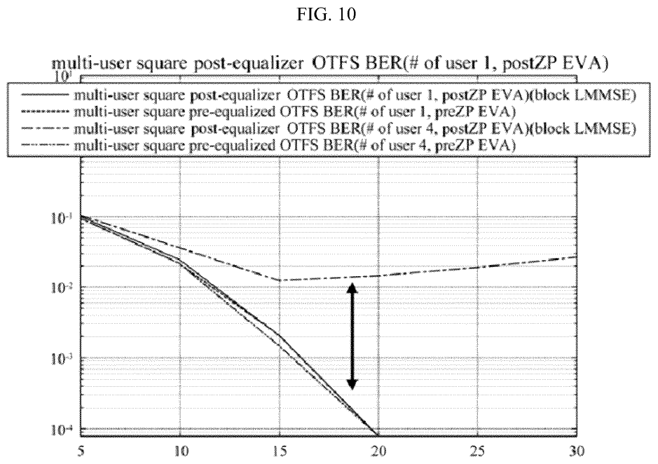

FIG. 10 is a graph comparing bit error rate (BER) performances of the existing OTFS communication system and the OTFS communication system of the present disclosure in a multi-user environment. Here, for a case where there are four users and the speed of the moving object is 500 km/h, the comparison is made.

Referring to FIG. 10, it can be seen that the existing OTFS communication system (post-equalized) does not overcome high mobility in the multi-user environment and the BER performance deteriorates, while the OTFS communication system of the present disclosure (pre-equalized) maintains the BER performance even in the multi-user environment.

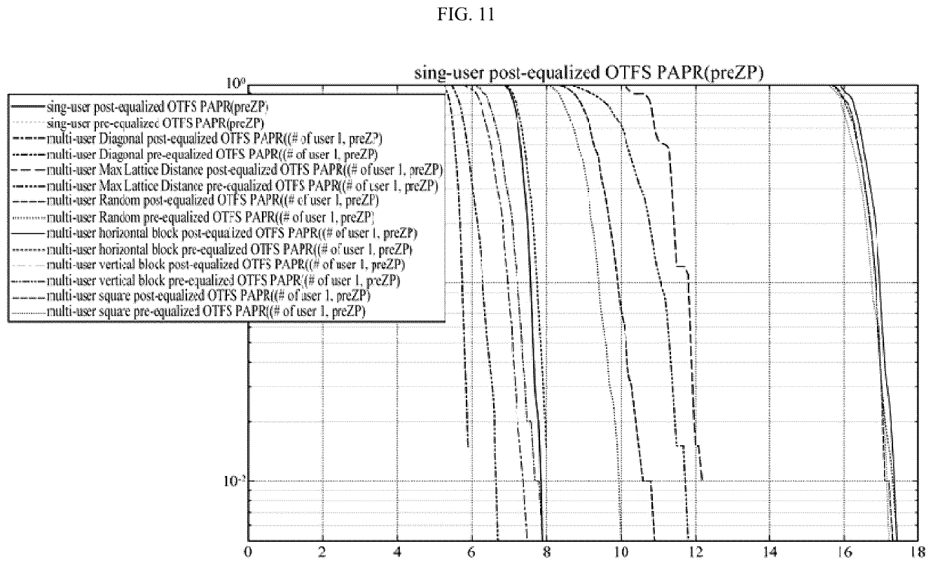

FIG. 11 is a graph comparing peak to average power ratio (PAPR) performances of the existing OTFS communication system and the OTFS communication system of the present disclosure. In FIG. 11, the solid line shows the PAPR performance of the existing OTFS communication system, and the dotted line shows the PAPR performance of the OTFS communication system of the present disclosure.

Looking at FIG. 11, it can be seen that the OTFS communication system of the present disclosure is little different from the existing OTFS communication system in terms of PAPR performance even though the transmitter transmits the signal after performing channel equalization in advance.

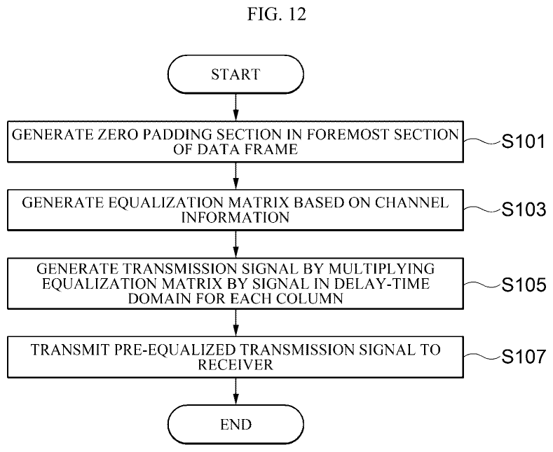

FIG. 12 is a flowchart showing a communication method of a communication system according to one embodiment of the present disclosure. In the illustrated flowchart, the method is divided into a plurality of steps; however, at least some of the steps may be performed in a different order, performed together in combination with other steps, omitted, performed in subdivided steps, or performed by adding one or more steps not illustrated.

Referring to FIG. 12, the transmitter 102 may generate a zero padding section in the foremost section of the data frame in the delay-time domain (S101). Next, the transmitter 102 may acquire channel information between the transmitter 102 and the receiver 104 and generate an equalization matrix based on the acquired channel information (S103).

Next, the transmitter 102 may generate a transmission signal by multiplying the equalization matrix by the signal in the delay-time domain for each column (S105). Next, the transmitter 102 may transmit the pre-equalized transmission signal to the receiver 104 (S107).

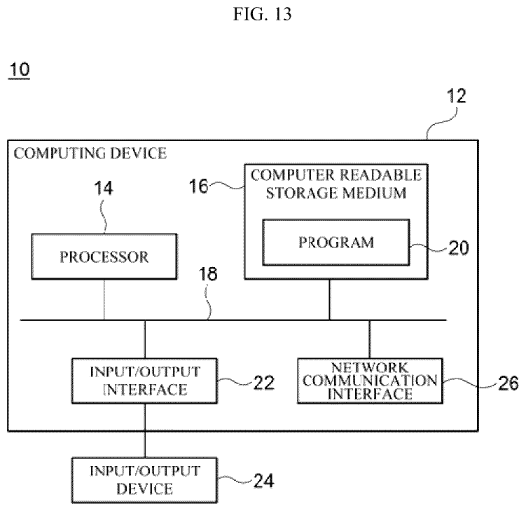

FIG. 13 is a block diagram exemplarily illustrating a computing environment 10 that includes a computing device suitable for use in exemplary embodiments. In the illustrated embodiment, each component may have a different function and capability in addition to those described below, and additional components may be included in addition to those described below.

The illustrated computing environment 10 includes a computing device 12. In one embodiment, the computing device 12 may be the transmitter 102. Further, the computing device 12 may be the receiver 104.

The computing device 12 includes at least one processor 14, a computer-readable storage medium 16, and a communication bus 18. The processor 14 may cause the computing device 12 to operate according to the above-described exemplary embodiments. For example, the processor 14 may execute one or more programs stored in the computer-readable storage medium 16. The one or more programs may include one or more computer-executable instructions, which may be configured to cause, when executed by the processor 14, the computing device 12 to perform operations according to the exemplary embodiments.

The computer-readable storage medium 16 is configured to store computer-executable instructions or program codes, program data, and/or other suitable forms of information. A program 20 stored in the computer-readable storage medium 16 includes a set of instructions executable by the processor 14. In one embodiment, the computer-readable storage medium 16 may be a memory (a volatile memory such as a random-access memory, a non-volatile memory, or any suitable combination thereof), one or more magnetic disk storage devices, optical disc storage devices, flash memory devices, other types of storage media that are accessible by the computing device 12 and may store desired information, or any suitable combination thereof.

The communication bus 18 interconnects various other components of the computing device 12, including the processor 14 and the computer-readable storage medium 16.

The computing device 12 may also include one or more input/output interfaces 22 that provide an interface for one or more input/output devices 24, and one or more network communication interfaces 26. The input/output interface 22 and the network communication interface 26 are connected to the communication bus 18. The input/output device 24 may be connected to other components of the computing device 12 via the input/output interface 22. The exemplary input/output device 24 may include a pointing device (a mouse, a trackpad, or the like), a keyboard, a touch input device (a touch pad, a touch screen, or the like), a voice or sound input device, input devices such as various types of sensor devices and/or imaging devices, and/or output devices such as a display device, a printer, an interlocutor, and/or a network card. The exemplary input/output device 24 may be included inside the computing device 12 as one of components constituting the computing device 12, or may be connected to the computing device 12 as a separate device distinct from the computing device 12.

Although the representative embodiments of the present disclosure have been described in detail as above, those skilled in the art will understand that various modifications may be made thereto without departing from the scope of the present disclosure. Therefore, the scope of rights of the present disclosure should not be limited to the described embodiments, but should be defined not only by the claims set forth below but also by equivalents of the claims.

1: A communication method for signal transmission of a transmitter in a communication system using pre-channel equalization, the communication method being performed in a computing device including one or more processors and a memory storing one or more programs executed by the one or more processors, the communication method comprising:
generating a zero padding section or a cyclic prefix (CP) section in a foremost section of a data frame in any one of a delay-Doppler domain, a frequency-time domain, and a delay-time domain; and
generating a transmission signal by performing pre-equalization on a signal in any one of the delay-Doppler domain, the frequency-time domain, and the delay-time domain.

2: The communication method of claim 1, wherein the pre-equalization is to perform compensation in a direction opposite to spread of data to occur in a channel between the transmitter and a receiver in advance before transmitting a signal from the transmitter to the receiver.

3: The communication method of claim 2, wherein the generating of the transmission signal comprises:
acquiring channel information between the transmitter and a receiver to receive the transmission signal;
generating an equalization matrix based on the channel information; and
generating the transmission signal by multiplying the equalization matrix by a signal in any one of the delay-Doppler domain, the frequency-time domain, and the delay-time domain for each column.

4: The communication method of claim 3, wherein the equalization matrix (Hpre) is generated by Equation 1 or Equation 2 below.
$${H}_{pre} = \frac{{G}_{n}^{H}}{{G}_{n} {G}_{n}^{H} + {σ}_{0}^{2} {I}_{M}} \qquad ( Equation 1 )$$
$${H}_{pre} = \frac{{G}_{n}^{H}}{{G}_{n} {G}_{n}^{H}} \qquad ( Equation 2 )$$
Gₙ: Channel matrix for an n-th column of a signal matrix in the delay-time domain
$${G}_{n}^{H} :$$
Hermitian matrix of Gₙ
$${σ}_{0}^{2} :$$
Dispersion of noise of a corresponding channel
I_{M}: Identity matrix corresponding to a length M of the n-th column of the signal matrix in the delay-time domain

5: The communication method of claim 4, wherein in the generating of the transmission signal, the transmission signal (x_{pre,n}) is generated by multiplying the equalization matrix for each column according to Equation 3 or Equation 4 below, and each column of the transmission signal is concatenated to generate a matrix of the transmission signal.
$${x}_{pre , n} = \frac{{G}_{n}^{H}}{{G}_{n} {G}_{n}^{H} + {σ}_{0}^{2} {I}_{M}} {x}_{n} \qquad ( Equation 3 )$$
$${x}_{pre , n} = \frac{{G}_{n}^{H}}{{G}_{n} {G}_{n}^{H}} {x}_{n} \qquad ( Equation 4 )$$
xₙ: n-th column of the signal matrix in the delay-time domain

6: The communication method of claim 2, wherein the communication system is an orthogonal time frequency space (OTFS) communication system, and
the communication method further comprises, prior to the generating of the zero padding section or the CP section,
receiving data bits, digitally modulating the data bits, and mapping the modulated data symbols to the delay-Doppler domain;
performing inverse symplectic fast Fourier transform (ISFFT) on the signal in the delay-Doppler domain to convert the signal into a signal in the frequency-time domain; and
performing inverse fast Fourier transform (IFFT) on the signal in the frequency-time domain to generate a signal in the delay-time domain.

7: The communication method of claim 2, wherein the communication system is an orthogonal frequency division multiplexing (OFDM) communication system, and
the communication method further comprises, prior to the generating of the zero padding section or the CP section,
receiving data bits, digitally modulating the data bits, and mapping the modulated data symbols to the frequency-time domain; and
performing inverse fast Fourier transform (IFFT) on the signal in the frequency-time domain to generate a signal in the delay-time domain.

8: A communication method for signal reception of a receiver in a communication system using pre-channel equalization, the communication method being performed in a computing device including one or more processors and a memory storing one or more programs executed by the one or more processors, the communication method comprising:
receiving, from a transmitter, a transmission signal for which a zero padding section or a cyclic prefix (CP) section is generated in a foremost section of a data frame in any one of a delay-Doppler domain, a frequency-time domain, and a delay-time domain and in which pre-equalization in performed on a signal in any one of the delay-Doppler domain, the frequency-time domain, and the delay-time domain.

9: A communication system using pre-channel equalization, the communication system comprising:
a transmitter; and
a receiver,
wherein the transmitter includes a channel equalizer configured to generate a transmission signal by generating a zero padding section or a cyclic prefix (CP) section in a foremost section of a data frame in any one of a delay-Doppler domain, a frequency-time domain, and a delay-time domain, and performing pre-equalization on a signal in any one of the delay-Doppler domain, the frequency-time domain, and the delay-time domain.

10: The communication system of claim 9, wherein the pre-equalization is to perform compensation in a direction opposite to spread of data to occur in a channel between the transmitter and a receiver in advance before transmitting a signal from the transmitter to the receiver.

11: The communication system of claim 10, wherein the channel equalizer acquires channel information between the transmitter and a receiver to receive the transmission signal, generates an equalization matrix based on the channel information, and generates the transmission signal by multiplying the equalization matrix by a signal in any one of the delay-Doppler domain, the frequency-time domain, and the delay-time domain for each column.

12: The communication system of claim 11, wherein the equalization matrix (Hpre) is generated by Equation 1 or Equation 2 below.
$${H}_{pre} = \frac{{G}_{n}^{H}}{{G}_{n} {G}_{n}^{H} + {σ}_{0}^{2} {I}_{M}} \qquad ( Equation 1 )$$
$${H}_{pre} = \frac{{G}_{n}^{H}}{{G}_{n} {G}_{n}^{H}} \qquad ( Equation 2 )$$
Gₙ: Channel matrix for an n-th column of a signal matrix in the delay-time domain
$${G}_{n}^{H} :$$
Hermitian matrix of Gₙ
$${σ}_{0}^{2} :$$
Dispersion of noise of a corresponding channel
I_{M}: Identity matrix corresponding to a length M of the n-th column of the signal matrix in the delay-time domain

13: The communication system of claim 12, wherein the channel equalizer generates the transmission signal (x_{pre,n}) by multiplying the equalization matrix for each column according to Equation 3 or Equation 4 below, and each column of the transmission signal is concatenated to generate a matrix of the transmission signal.
$${x}_{pre , n} = \frac{{G}_{n}^{H}}{{G}_{n} {G}_{n}^{H} + {σ}_{0}^{2} {I}_{M}} {x}_{n} \qquad ( Equation 3 )$$
$${x}_{pre , n} = \frac{{G}_{n}^{H}}{{G}_{n} {G}_{n}^{H}} {x}_{n} \qquad ( Equation 4 )$$
xₙ: n-th column of the signal matrix in the delay-time domain

14: The communication system of claim 10, wherein the communication system is an orthogonal time frequency space (OTFS) communication system, and
the transmitter, before generating the zero padding section or the CP section, receives data bits, digitally modulates the data bits, and maps the modulated data symbols to the delay-Doppler domain, performs inverse symplectic fast Fourier transform (ISFFT) on the signal in the delay-Doppler domain to convert the signal into a signal in the frequency-time domain, and performs inverse fast Fourier transform (IFFT) on the signal in the frequency-time domain to generate a signal in the delay-time domain.

15: The communication system of claim 14, wherein the receiver receives the pre-equalized transmission signal from the transmitter, performs fast Fourier transform (FFT) on the received signal in the delay-time domain to convert the received signal into a signal in the frequency-time domain, and performs symplectic fast Fourier transform (SFFT) on the signal in the frequency-time domain to generate an original data estimation signal in the delay-Doppler domain.

16: The communication system of claim 10, wherein the communication system is an orthogonal frequency division multiplexing (OFDM) communication system, and
the transmitter, before generating the zero padding section or the CP section,
receives data bits, digitally modulates the data bits, and maps the modulated data symbols to the frequency-time domain, and performs inverse fast Fourier transform (IFFT) on the signal in the frequency-time domain to generate a signal in the delay-time domain.

17-20: (canceled)
